(19) United States
(12) Patent Application Publication
(10) Pub. No.: US 2006/0130845 A1
(43) Pub. Date: Jun. 22, 2006

(54) Respirator mask with hygienic protection

(76) Inventor: Robert Schegerin, Velizy Cedex (FR)

Correspondence Address: JOHN S. PRATT, ESQ;KILPATRICK STOCKTON, LLP, 1100 PEACHTREE STREET, ATLANTA, GA, 30309, US

(21) Appl. No.: 10/555,816

(22) PCT Filed: May 14, 2004
(86) PCT No.: PCT/FR04/01195

§ 371 Date: Nov. 7, 2005

(30) Foreign Application Priority Data
May 16, 2003 (FR) 03/05993

(51) Int. Cl. A62B 18/02; A62B 18/08

(52) U.S. Cl. 128/206.28; 128/206.27; 128/206.26

(57) ABSTRACT

The invention relates to a respirator mask with hygienic protection. More specifically, the invention relates to a respirator face mask (2) which provides physiological protection, comprising: an oronasal face piece (10), a semi-flexible lip element (6) which is used to position the oronasal face piece (10) on the user's face (1), and hygienic protection means (4) which are removably-positioned at least partially inside the mask (2). The aforementioned removable protection means (4) comprise (i) a first part (4a) which provides hygienic protection and (ii) a second part (4b) which maintains the hygienic protection means (4) inside the mask (2), said second part (4b) co-operating elastically with the above-mentioned semi-flexible lip element (6) or the face piece (10).

The present invention relates to respirator masks with hygienic protection.

More specifically, the present invention relates to respirator face masks providing physiological protection, particularly for aircraft flight crew.

The invention relates, for example, to the respiratory protection masks used by civil airplane pilots to combat hypoxia in particular. The protection masks for civil airplane pilots are part of the airplane and are used by several pilots in turn, particularly for tests or preventive uses of the masks. It will be understood that this causes a degree of physiological discomfort for the pilots and that it is not without risk concerning certain infections.

One object of the invention is to overcome at least some of the abovementioned drawbacks.

To this end, there is proposed, according to the invention, a respirator face mask providing physiological protection, particularly for aircraft flight crew, comprising:
an oronasal face piece designed to be connected to a respiratory gas source,
a semi-flexible lip element with an edge designed to position the oronasal face piece on the face of a user, and
hygienic protection means which are removably positioned at least partially inside the mask and including a first part which provides hygienic protection and a second part which maintains the hygienic protection means inside the mask, this second part co-operating elastically with the semi-flexible lip element or the face piece.

The hygienic protection means are removable and can therefore be easily replaced between consecutive uses. This is made particularly possible by the second part which cooperates elastically with the semi-flexible lip element or the face piece. Besides the fact that this elastic cooperation facilitates the fitting of the hygienic protection means on the mask and their removal from the mask, it can, if necessary, be used to provide a degree of seal-tightness between the hygienic protection means and the semi-flexible lip element or the face piece.

According to certain embodiments of the invention, for which separate patented protections may, if necessary, be sought individually at a later date, one and/or other of the following provisions may, if necessary, be applied:
the first and second parts of the hygienic protection means include different materials;
the second part is in contact with at least an internal part of the semi-flexible lip element;
a thin lip element prolongs, at least in certain areas, the second part, so as to extend a few millimeters beyond the free edge of the semi-flexible lip element;
the thin lip element is prolonged over at least an external part of the semi-flexible lip element;
the first part of the hygienic protection means includes a filter allowing the respiratory gases to pass through;
the first part at least partly filters any infection from the user;
the first part has a corrugated shape, in order to reduce the pressure drop of the hygienic protection means;
the corrugated shape corresponds to waves substantially centered about a central area of the hygienic protection means, to facilitate extraction of the hygienic protection means from the mask;
the mask includes a cord, attached to the hygienic protection means, facilitating the extraction of the hygienic protection means from the mask;
the second part is made of silicone;
the first part of the hygienic protection means covers an area of the semi-flexible lip element which, in the absence of hygienic protection means, would have been in contact with the face once the mask was in place on the latter;
the second part includes an elastic thread gripping the semi-flexible lip element;
a flexible structure is placed between the hygienic protection means and an internal part of the semi-flexible lip element and extending beyond the latter;
a flexible structure is placed outside the hygienic protection means, inside the semi-flexible lip element and extending beyond the latter;
the mask includes:
   a part located outside the semi-flexible lip element and including a structural part providing the seal between the semi-flexible lip element and the hygienic protection means,
   another part located over the entire external part of the semi-flexible lip element which, in the absence of hygienic protection means, would have been in contact with the face once the mask was in place on the latter, and
a third part which is designed to be pressed onto the face, by the effect of the pressure of the respiratory gas inside the mask, when the mask is worn, to provide a seal between the protection means and the face;
the structural part exerts a mechanical pressure on the semi-flexible lip element, the value of which is greater than the maximum value of the maximum pressure of the respiratory gas, which can prevail inside the mask;
the first, second and third areas are formed by a single elastic film; and
the structural part includes an elastic thread.

Other aspects, objects and advantages of the invention will become apparent from reading the description of a number of these embodiments.

The invention will be better understood with the help of the drawings in which:

FIG. 1 diagrammatically represents a vertical cross-section of a respiratory device comprising an example of a first embodiment of a mask according to the invention, worn by a user;

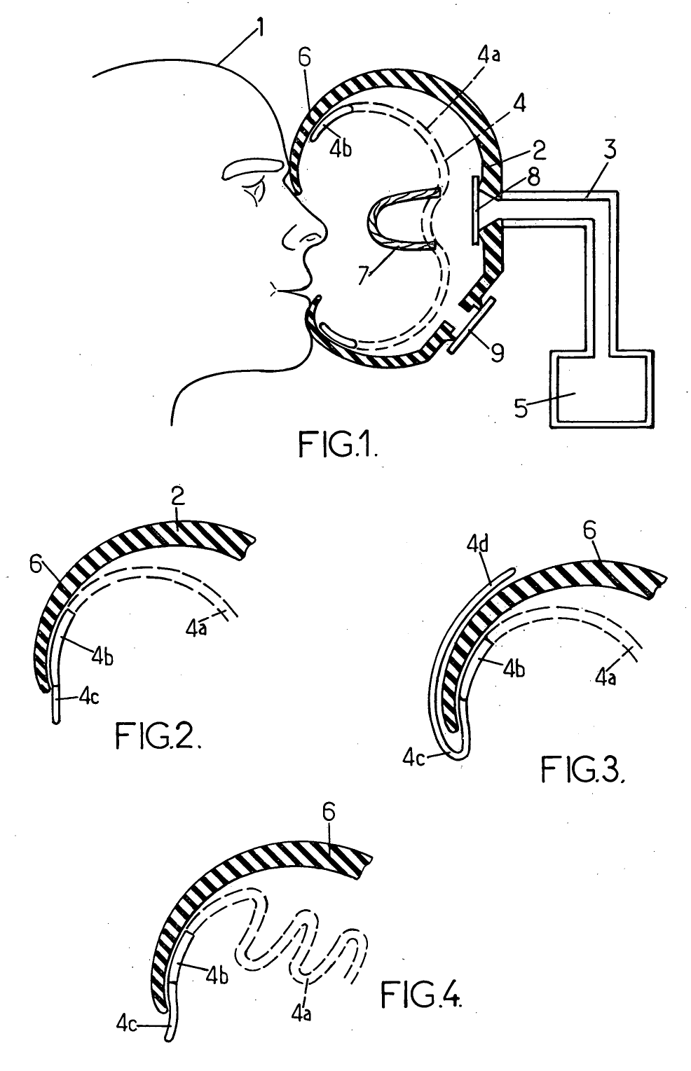

FIG. 2 diagrammatically represents, through a cross-section similar to that of FIG. 1, a detail of a variant of the embodiment of FIG. 1;

FIG. 3 diagrammatically represents, through a cross-section similar to those of FIGS. 1 and 2, a detail of another variant of the embodiment of FIG. 1;

FIG. 4 diagrammatically represents, through a cross-section similar to those of FIGS. 1, 2 and 3, a detail of yet another variant of the embodiment of FIG. 1;

FIG. 5 diagrammatically represents, in elevation, an example of a second embodiment of a mask according to the invention;

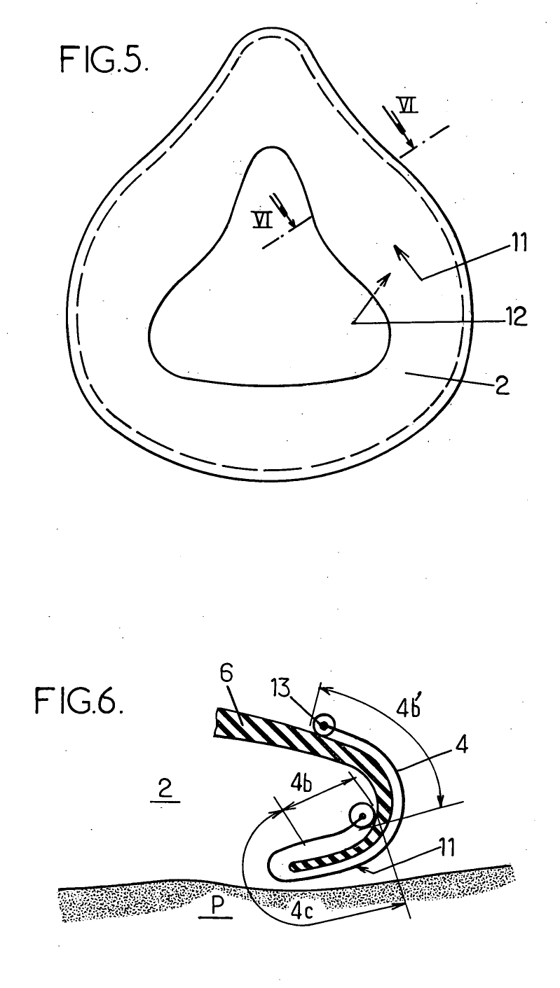

FIG. 6 diagrammatically represents, through a cross-section in the plane VI-VI of FIG. 5, a detail of the embodiment of FIG. 5; and

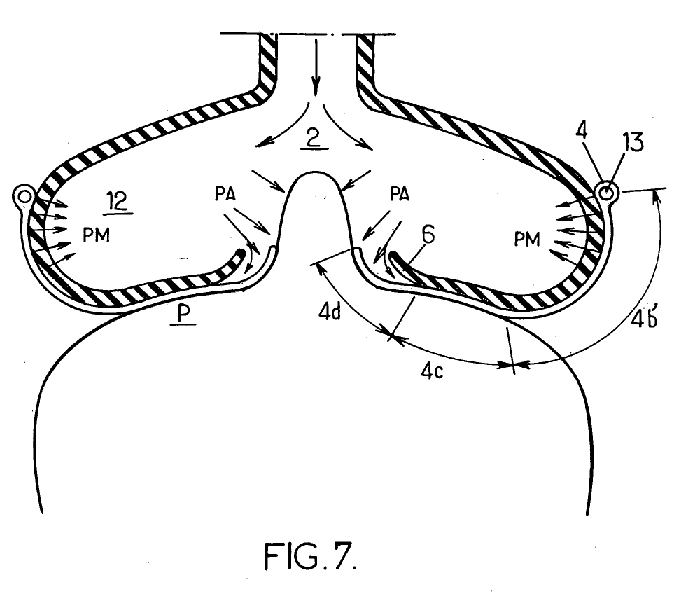

FIG. 7 diagrammatically represents, in horizontal cross section, an example of a third embodiment of a mask according to the invention, worn by a user.

In the various figures, like references denote identical or similar elements.

A first exemplary embodiment of the mask according to the invention is shown in FIG. 1.

In FIG. 1, a user 1, in this case a civil airplane pilot, is wearing a respiratory protection mask 2, in this case a quick-fitting mask. This mask 2 includes an oronasal face piece 10 and a semi-flexible lip element 6. A pipe 3 conveying a respiratory gas supplies the mask 2 with respiratory gas from a respiratory gas source 5. This pipe 3 is connected in a fluid manner to the oronasal face piece 10. Removable hygienic protection means 4, in this case a filter, are placed by the pilot inside the mask 2, for example when he takes his seat in the airplane. These hygienic protection means 4 are made up of at least two main parts 4a and 4b. The part 4a filters the air breathed out and prevents any infection from penetrating inside the mask and in particular in a microphone or inspiratory 8 and/or expiratory 9 valves. The part 4a for example is made of a paper impregnated with an antibiotic, bactericidal or other substance. The part 4b is made of a flexible and airtight material, such as silicone or latex, for example, and is used to secure the hygienic protection means 4 inside the mask 2, and maintain the seal of the hygienic protection means 4 with the mask 2 by contact between this part 4b and the inside of the semi-flexible lip element 6. If necessary, a cord 7 is fixed to the hygienic protection means 4 to facilitate their extraction from the mask 2.

According to a variant, illustrated by FIG. 2, a third part 4c, forming a thin lip element, prolongs the part 4b and extends beyond the semi-flexible lip element 6 by a few millimeters to make the mask 2 more comfortable to wear and to improve the seal between the hygienic protection means 4 and face of the user 1. This part 4b is, for example, also made of silicone or latex, but is thinner than the part 4b.

According to another variant, illustrated by FIG. 3, a fourth part 4d, also forming a thin lip element, prolongs the part 4c so as to least partly cover the outer surface of the semi-flexible lip element 6. This part 4d also provides a hygienic protection function. It can also be made of silicone or latex like the part 4c.

According to yet another variant, illustrated by FIG. 4, the part 4a has a corrugated shape, with corrugations substantially centered inside the mask 2 and/or the inspiratory valve 8, in order to reduce the pressure drop and/or facilitate the handling and/or extraction and replacement of the hygienic protection means 4.

A second exemplary embodiment of the mask according to the invention is shown in FIGS. 5 and 6.

According to this second embodiment, the mask 2 according to the invention includes an oronasal face piece, a semi-flexible lip element and fluid connection means similar to those of the embodiment described above. FIG. 5 more particularly represents the semi-flexible lip element 6, the edge 11 of which, intended to be in contact with the face of a user, is covered by hygienic protection means 4. This edge returns toward the center and the interior of the mask 2, forming an internal groove 12.

FIG. 6 mainly represents this edge 11 of the semi-flexible lip element 6. The hygienic protection means 4, in this case a thin film, includes:
a part 4c which insulates the semi-flexible lip element 6 from the skin P of the user 1,
another, so-called structural, part 4b, which rests in the hollow of the semi-flexible lip element 6, preventing the hygienic protection means 4 from coming away from the mask 2, and
yet another part 4b′, placed outside the mask 2, preventing the hygienic protection means 4 from entering into the mask 2 when it is used and if possibly including an elastic thread 13 gripping the semi-flexible lip element 6.

The part 4c which insulates the semi-flexible lip element 6 from the skin P of the user 1 is placed all around this semi-flexible lip element 6. It is placed on the external part of the semi-flexible lip element 6, but, possibly, also over a large portion of its internal part. This part 4c is made of silicone, latex or a fibrous or woven material, for example.

The so-called structural part 4b is more rigid than the part 4c. It is, for example, made of silicone or latex. It has a shape designed to fit inside the internal groove 12 of the semi-flexible lip element 6. It provides for stable positioning of the hygienic protection means 4, preventing them from coming away from the mask 2 while the latter is being used.

The last part 4b′, the one possibly including an elastic thread 13, is fixed all around the outer perimeter of the hygienic protection means 4 in order to keep them stably positioned by preventing them from re-entering into the mask 2 while it is being used. This part 4b′ can be made of silicone or latex, for example.

This architecture takes into account the possible elastic distortions of the mask 2, of the structural part 4b and of the possible thread 13, so that the assembly comprising the hygienic protection means 4, the structural part 4b and the possible elastic thread 13, can easily be replaced after each use.

According to a variant, a flexible structure is placed between the hygienic protection means 4 and an internal part of the semi-flexible lip element 6. This flexible structure, such as a thin film of silicone or latex, for example, extends beyond the semi-flexible lip element 6. In place of or in addition to this flexible structure, another flexible structure, such as a thin film, can be placed outside the hygienic protection means 4, inside the semi-flexible lip element 6 and extending beyond the latter.

A third exemplary embodiment of the mask according to the invention is represented in FIG. 7.

As for the embodiments described previously, this third embodiment of the mask 2 according to the invention includes an oronasal face piece, a semi-flexible lip element and fluid connection means similar to those described above.

FIG. 7 more particularly represents the semi-flexible lip element 6, the edge 11 of which, intended to be in contact with the face of a user, is provided with hygienic protection means 4. This edge 11 returns toward the center and the interior of the mask 2, forming an internal groove 12.

In this example, the hygienic protection means 4 are mainly placed outside the semi-flexible lip element 6. The hygienic protection means 4 mainly comprise a thin film which surrounds the semi-flexible lip element 6 on the outside. The intrinsic elasticity of this thin film enables it to be placed easily around the semi-flexible lip element 6. This thin film is, for example, made of silicone or latex.

The hygienic protection means 4 comprise three parts:
a part 4b′ on which the thin film is pulled against the semi-flexible lip element 6; this area can be strengthened by a reinforcing structure consisting of an elastic thread 13 incorporated in the thin film; this particular arrangement allows the thin film to be replaced easily and firmly presses it on the outside of the semi-flexible lip element 6 by creating a pressure PM providing the seal between the thin film and the semi-flexible lip element 6; the elastic characteristics of the assembly comprising the thin film and the reinforcing structure are chosen so that the pressure PM exerted is greater than the relative pressure PA of the air contained inside the mask 2, but without being too great to avoid significantly distorting the semi-flexible lip element 6;
a part 4c placed between the skin P and the semi-flexible lip element 6 which forms a hygienic protection; and
a part 4d extending beyond the semi-flexible lip element 6; this part is very flexible, is used to follow the contours of the skin P and any folds in it and thus provide the seal between the skin P and the thin film.

This thin film therefore provides a seal that is significantly better than the masks of the prior art.

The hygienic protection means described above are particularly economical, making their use and their regular replacement less costly.

The hygienic protection means can be stored in a sealed, sterile and possibly transparent plastic bag, also including disinfecting wipes. When the pilot is preparing his mask before a flight, he can therefore also clean the lips of the mask and of the visor before replacing the mask in the mask box.

1-19. (canceled)

20. A respirator face mask providing physiological protection, comprising:
an oronasal face piece which is connectable to a respiratory gas source,
a semi-flexible lip element with an edge designed to position said oronasal face piece on a user's face and,
hygienic protection means which are removably positioned at least partly inside said mask and including a first part which provides hygienic protection and a second part which maintains said hygienic protection means inside said mask, said second part co-operating elastically with one of said semi-flexible lip element and the face piece.

21. The mask as claimed in claim 20, wherein said first and second parts of said hygienic protection means include different materials.

22. The mask as claimed in claim 20, wherein said second part of said hygienic protection means is in contact with at least an internal part of said semi-flexible lip element.

23. The mask as claimed in one claim 20, wherein a thin lip element of said hygienic protection means prolongs, in at least one area, said second part, of said hygienic protection means, so as to extend a few millimeters beyond said edge of said semi-flexible lip element.

24. The mask as claimed in claim 23, wherein said thin lip element is prolonged over at least an external part of said semi-flexible lip element.

25. The mask as claimed in claim 20, wherein said first part of said hygienic protection means includes a filter which is permeable to respiratory gases.

26. The mask as claimed in claim 25, wherein said first part at least partly filters any infection from a user.

27. The mask as claimed in claim 20, wherein said first part of said hygienic protection means has a corrugated shape, for reducing the pressure drop of said hygienic protection means.

28. The mask as claimed in claim 27, wherein said corrugated shape corresponds to waves substantially centered about a central area of said hygienic protection means, so as to facilitate extraction of said hygienic protection means from said mask.

29. The mask as claimed in claim 20 including a cord, attached to said hygienic protection means, for facilitating extraction of said hygienic protection means from said mask.

30. The mask as claimed in claim 20 wherein said second part of said hygienic protection means is made of silicone.

31. The mask as claimed in claim 20, wherein said first part of said hygienic protection means covers an area of said semi-flexible lip element which, in the absence of said hygienic protection means, would have been in contact with said user's face once said mask was in place on said user's face.

32. The mask as claimed in claim 20, wherein said second part of said hygienic protection means includes an elastic thread gripping said semi-flexible lip element.

33. The mask as claimed in claim 20 wherein a flexible structure is placed between said hygienic protection means and an internal part of said semi-flexible lip element, said flexible structure extending beyond said semi-flexible lip element.

34. The mask as claimed in claim 20, wherein a flexible structure is placed outside said hygienic protection means, and inside said semi-flexible lip element said extendible structure extending beyond said semi-flexible lip element.

35. The mask as claimed in claim 20 including:
a part of said hygienic protection means which is located outside said semi-flexible lip element and including a structural part providing a seal between a semi-flexible lip element and said hygienic protection means,
another part of said hygienic protection means which is located over an external area of said semi-flexible lip element which, in the absence of said hygienic protection means (4), would have been in contact with said user's face once said mask was in place on said user's face, and
yet another part of said hygienic protection means which is designed to be pressed onto said user's face, by the effect of a pressure of respiratory gas inside said mask, when said mask is worn, to provide a seal between said hygienic protection means and said user's face.

36. The mask as claimed in claim 35, wherein said structural part exerts a mechanical pressure on said semi-flexible lip element, which is greater than a maximum pressure of respiratory gas, which can prevail inside said mask.

37. The mask as claimed in claim 35, wherein said three parts are formed by a single elastic film.

38. The mask as claimed in claim 35, wherein said structural part includes an elastic thread.
